(19) United States
(12) Patent Application Publication
(10) Pub. No.: US 2016/0301620 A1
(43) Pub. Date: Oct. 13, 2016

(54) SETTING PARAMETERS PERTAINING TO SERVICE PERIOD FOR REDUCED LATENCY IN WIRELESS COMMUNICATION

(71) Applicant: QUALCOMM Incorporated, San Diego, CA (US)

(72) Inventors: Lochan Verma, San Diego, CA (US); Xiaodong Wang, San Diego, CA (US); Vijayalakshmi Rajasundaram Raveendran, San Diego, CA (US)

(21) Appl. No.: 14/682,028

(22) Filed: Apr. 8, 2015

(51) Int. Cl. H04L 12/875; H04L 12/26

(52) U.S. Cl. CPC H04L 47/56; H04L 43/0876

(57) ABSTRACT

The disclosure provides methods, apparatus, and computer-readable medium for setting parameters pertaining to service period (SP) for reduced latency in wireless communication. The apparatus may determine whether an amount of data at a medium access control (MAC) layer at the apparatus exceeds a maximum amount of data transmittable in a single transmission opportunity (TXOP). If so, the apparatus sets a duration of the SP for transmission of the data to be greater than or equal to a duration required for transmitting the data, and the apparatus transmits the data during the set duration of the SP. The apparatus may also set a duration of a service period interval (SPI) to be greater than or equal to the duration of the SP and less than or equal to a duration for transmitting the data using the single TXOP. The data may be latency-sensitive data, such as isochronous data or interrupt data.

### TECHNICAL FIELD

Aspects of the present disclosure relate, generally, to wireless communication and, more particularly, to setting parameters pertaining to service period (SP) for reduced latency in wireless communication.

### BACKGROUND

Wireless communication networks are widely deployed to provide various communication services such as telephony, video, data, messaging, broadcasts, and other suitable services. Recent interest has been directed toward enhancing the efficiency of such communications as well as improving the overall user experience. Various communication networks may utilize a contention-based system for determining whether to transmit data over a channel. For example, an apparatus may ‘remain quiet’ (e.g., refrain from transmitting) and ‘listen’ (e.g., detect the presence of another signal on the channel) before ‘speaking’ (e.g., transmitting on the channel).

Such a contention-based system introduces a delay between each period of transmission. While the apparatus is ‘remaining quiet’ and ‘listening,’ the apparatus is not ‘speaking.’ Because the apparatus is unable to ‘speak’ during such periods of time, the following undesirable effects may be occurring: (1) the queues of data to be transmitted may be getting longer and possibly congested, and (2) latency may be introduced between each period of transmission. Such undesirable effects may adversely impact the user experience. For instance, such undesirable effects may introduce gaps in the transmission and eventual reception of latency-sensitive data, such as audio data. Accordingly, communication systems may benefit from enhancements that overcome such limitations and enhance the quality of the user experience.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In an aspect, the present disclosure provides a method of wireless communication by an apparatus. The method may include determining whether an amount of data at a medium access control (MAC) layer at the apparatus exceeds a maximum amount of data transmittable in a single transmission opportunity (TXOP). If the amount of data at the MAC layer exceeds the maximum amount of data transmittable in the single TXOP, the method may also include setting a duration of a service period (SP) to be greater than or equal to a duration required for transmitting the data, and transmitting the data during the set duration of the SP.

In another aspect, the present disclosure provides an apparatus for wireless communication. The apparatus may include a memory, a transceiver, and at least one processor communicatively coupled to the memory and the transceiver. The at least one processor may be configured to determine whether an amount of data at a MAC layer at the apparatus exceeds a maximum amount of data transmittable in a single TXOP. If the amount of data at the MAC layer exceeds the maximum amount of data transmittable in the single TXOP, the at least one processor may also be configured to set a duration of the SP to be greater than or equal to a duration required for transmitting the data, and utilizing the transceiver to transmit the data during the set duration of the SP.

In yet another aspect, the present disclosure provides a computer-readable medium that includes computer-executable code. The computer-executable code may be configured for determining whether an amount of data at a MAC layer at an apparatus exceeds a maximum amount of data transmittable in a single TXOP. If the amount of data at the MAC layer exceeds the maximum amount of data transmittable in the single TXOP, the computer-executable code may also be configured for setting a duration of the SP to be greater than or equal to a duration required for transmitting the data, and transmitting the data during the set duration of the SP.

In a further aspect, the present disclosure provides an apparatus for wireless communication. The apparatus may include means for determining whether an amount of data at a MAC layer at the apparatus exceeds a maximum amount of data transmittable in a single TXOP. The apparatus may also include means for setting a duration of the SP to be greater than or equal to a duration required for transmitting the data and transmitting the data during the set duration of the SP, if the amount of data at the MAC layer exceeds the maximum amount of data transmittable in the single TXOP.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example hardware implementation of an apparatus including a processing system according to various aspects of the present disclosure.

FIGS. 2A-2B are diagrams illustrating an example of a topology of various apparatuses in a communication network.

FIGS. 3A-3B are diagrams illustrating another example of a topology of various apparatuses in a communication network.

FIG. 4 is a diagram illustrating an example of various protocol layers of a communication system.

FIG. 5 illustrates an example of communication by a conventional apparatus.

FIG. 6 illustrates an example of communication by an apparatus configured according to various aspects of the present disclosure.

FIG. 7 illustrates a comparison between communication by the conventional apparatus and communication by the apparatus configured according to various aspects of the present disclosure.

FIG. 8 is a diagram illustrating various methods and/or processes performed by the apparatus configured according to various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

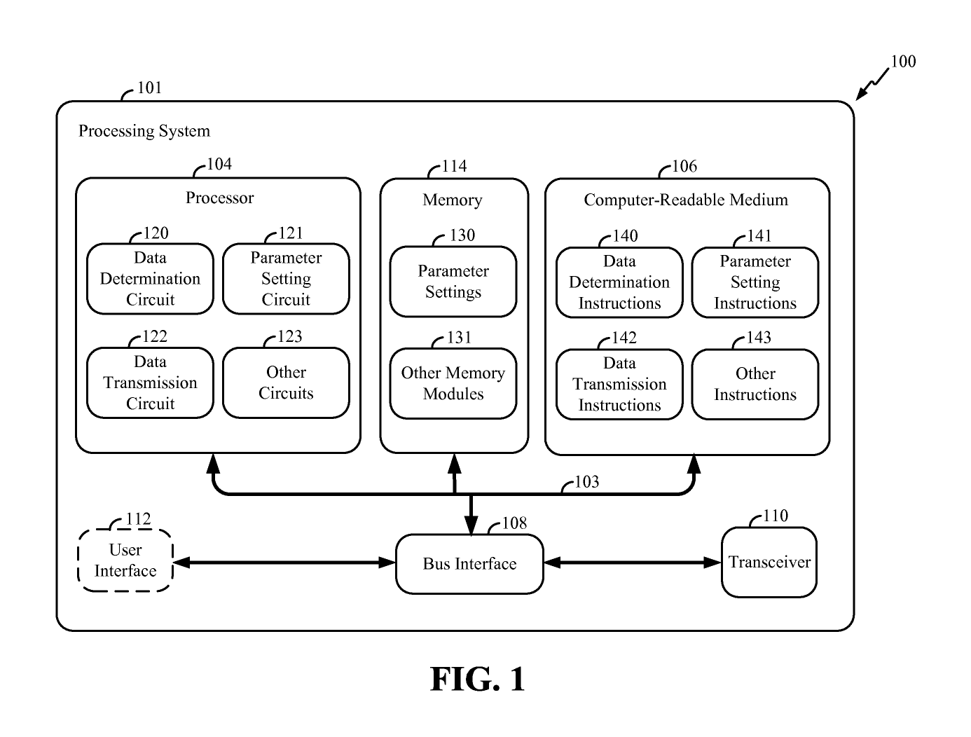

FIG. 1 is a conceptual diagram illustrating an example of a hardware implementation for an apparatus 100 including a processing system 101. By way of example and not limitation, the apparatus 100 may be any one or more of the apparatus, devices, and/or hosts described herein. By way of example and not limitation, the apparatus 100 may be a cellular telephone, a smartphone, user equipment, a tablet computer, a laptop computer, a personal digital assistant (PDA), a gaming device, an e-reader, a station (STA), a modem, an access point (AP), a router, a networking device, and/or any other apparatus configured to communicate with another apparatus.

The processing system 101 may implement various aspects of the disclosure, an element, any portion of an element, and/or any combination of elements. In some configurations, the processing system 101 may include a user interface 112. The user interface 112 may be configured to receive one or more inputs from a user of the processing system 101. The user interface 112 may also be configured to display information (e.g., text and/or images) to the user of the processing system 101. The user interface 112 may exchange data to and/or from the processing system 101 via the bus interface 108.

The processing system 101 may also include a transceiver 110. The transceiver 110 may be configured to receive data and/or transmit data in communication with another apparatus. The transceiver 110 provides a means for communicating with another apparatus via a wired and/or wireless transmission medium. In some configurations, the transceiver 110 provides the means for receiving data from another apparatus and/or the means for transmitting data to another apparatus. The transceiver 110 may be configured to perform such communications using various types of technologies. One of ordinary skill in the art will understand that many types of technologies to perform such communication may be used without deviating from the scope of the present disclosure.

The processing system 101 may also include a memory 114, one or more processors 104, a computer-readable medium 106, and a bus interface 108. The bus interface 108 may provide an interface between a bus 103 and the transceiver 110. The memory 114, the one or more processors 104, the computer-readable medium 106, and the bus interface 108 may be connected together via the bus 103. The processor 104 may be communicatively coupled to the transceiver 110 and/or the memory 114.

The processor 104 may include a data determination circuit 120. The data determination circuit 120 may include various hardware components and/or software modules that can perform various functions and/or enable various aspects associated with determining an amount of data at a particular protocol layer (e.g., a medium access control (MAC) layer). In some configurations, the data determination circuit 120 provides the means for determining whether an amount of data at the MAC layer exceeds a maximum amount of data transmittable in a single transmission opportunity (TXOP).

The processor 104 may also include a parameter setting circuit 121. The parameter setting circuit 121 may include various hardware components and/or software modules that can perform various functions and/or enable various aspects associated with setting a duration of a service period (SP) and/or setting a duration of a service period interval (SPI). In some circumstances, the amount of data at the MAC layer exceeds the maximum amount of data transmittable in the single TXOP. In such circumstances, the parameter setting circuit 121 provides the means for setting the duration of the SP to be greater than or equal to a duration required for transmitting the data.

The processor 104 may also include a data transmission circuit 122. The data transmission circuit 122 may include various hardware components and/or software modules that can perform various functions and/or enable various aspects associated with transmitting data to another apparatus. As described above, in some circumstances, the amount of data at the MAC layer exceeds the maximum amount of data transmittable in the single TXOP, and the duration of the SP is set to be greater than or equal to a duration required for transmitting the data. In such circumstances, the data transmission circuit 122 provides the means for transmitting the data during the set duration of the SP. However, in some other circumstances, the amount of data at the MAC layer does not exceed the maximum amount of data transmittable in the single TXOP. In such circumstances, the data transmission circuit 122 provides the means for transmitting the data without using the SP. That is, in such circumstances, the data transmission circuit 122 provides the means for transmitting the data using the single TXOP.

The foregoing description provides a non-limiting example of the processor 104 of the processing system 101. Although various circuits have been described above, one of ordinary skill in the art will understand that the processor 104 may also include various other circuits 123 that are in addition and/or alternative(s) to circuits 120, 121, 122. Such other circuits 123 may provide the means for performing any one or more of the functions, methods, processes, features and/or aspects described herein.

The computer-readable medium 106 may include various instructions. The instructions may include computer-executable code configured to perform various functions and/or enable various aspects described herein. The computer-executable code may be executed by various hardware components (e.g., the processor 104) of the processing system 101. The instructions may be a part of various software programs and/or software modules.

The computer-readable medium 106 may include data determination instructions 140. The data determination instructions 140 may include computer-executable code configured for performing various functions and/or enable various aspects associated with determining an amount of data at a particular protocol layer (e.g., the MAC layer). In some configurations, the data determination instructions 140 may include computer-executable code configured for determining whether an amount of data at the MAC layer exceeds a maximum amount of data transmittable in a single TXOP.

The computer-readable medium 106 may also include parameter setting instructions 141. The parameter setting instructions 141 may include computer-executable code configured for performing various functions and/or enable various aspects associated with setting a duration of a SP and/or setting a duration of a SPI. In some circumstances, the amount of data at the MAC layer exceeds the maximum amount of data transmittable in the single TXOP. In such circumstances, the parameter setting instructions 141 may include computer-executable code configured for setting the duration of the SP to be greater than or equal to a duration required for transmitting the data.

The computer-readable medium 106 may also include data transmission instructions 142. The data transmission instructions 142 may include computer-executable code configured for performing various functions and/or enable various aspects associated with transmitting data to another apparatus. As described above, in some circumstances, the amount of data at the MAC layer exceeds the maximum amount of data transmittable in the single TXOP, and the duration of the SP is set to be greater than or equal to a duration required for transmitting the data. In such circumstances, the data transmission instructions 142 may include computer-executable code configured for transmitting the data during the set duration of the SP. However, in some other circumstances, the amount of data at the MAC layer does not exceed the maximum amount of data transmittable in the single TXOP. In such circumstances, the data transmission instructions 142 may include computer-executable code configured for transmitting the data without using the SP. That is, in such circumstances, the data transmission instructions 142 may include computer-executable code configured for transmitting the data using the single TXOP.

The foregoing description provides a non-limiting example of the computer-readable medium 106 of the processing system 101. Although various instructions (e.g., computer-executable code) have been described above, one of ordinary skill in the art will understand that the computer-readable medium 106 may also include various other instructions 143 that are in addition and/or alternative(s) to instructions 140, 141, 142. Such other instructions 143 may include computer-executable code configured for performing any one or more of the functions, methods, processes, features and/or aspects described herein.

The memory 114 may include various memory modules. The memory modules may be configured to store, and have read therefrom, various values and/or information by the processor 104, or any of its circuits 120, 121, 122, 123. The memory modules may also be configured to store, and have read therefrom, various values and/or information upon execution of the computer-executable code included in the computer-readable medium 106, or any of its instructions 140, 141, 142, 143. The memory 114 may include parameter settings 130. For example, the parameter settings 130 may include data pertaining to the duration of the SP and/or the duration of the SPI in accordance with various aspects of the present disclosure. One of ordinary skill in the art will also understand that the memory 114 may also include various other memory modules 131. The other memory modules 131 may be configured for storing information therein, and reading information therefrom, with respect to any of the features, functions, methods, processes, and/or aspects described herein.

One of ordinary skill in the art will also understand that the processing system 101 may include alternative and/or additional elements without deviating from the scope of the present disclosure. In accordance with various aspects of the present disclosure, an element, or any portion of an element, or any combination of elements may be implemented with a processing system 101 that includes one or more processors 104. Examples of the one or more processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system 101 may be implemented with a bus architecture, represented generally by the bus 103 and bus interface 108. The bus 103 may include any number of interconnecting buses and bridges depending on the specific application of the processing system 101 and the overall design constraints. The bus 103 may link together various circuits including the one or more processors 104, the memory 114, and the computer-readable media 106. The bus 103 may also link various other circuits such as timing sources, peripherals, voltage regulators, and power management circuits, which are well known in the art.

The one or more processors 104 may be responsible for managing the bus 103 and general processing, including the execution of software stored on the computer-readable medium 106. The software, when executed by the one or more processors 104, causes the processing system 101 to perform the various functions described below for any one or more apparatuses. The computer-readable medium 106 may also be used for storing data that is manipulated by the one or more processors 104 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may also include, by way of example, a carrier wave, a transmission line, and any other suitable medium for transmitting software and/or instructions that may be accessed and read by a computer. The computer-readable medium 106 may reside in the processing system 101, external to the processing system 101, or distributed across multiple entities including the processing system 101. The computer-readable medium 106 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

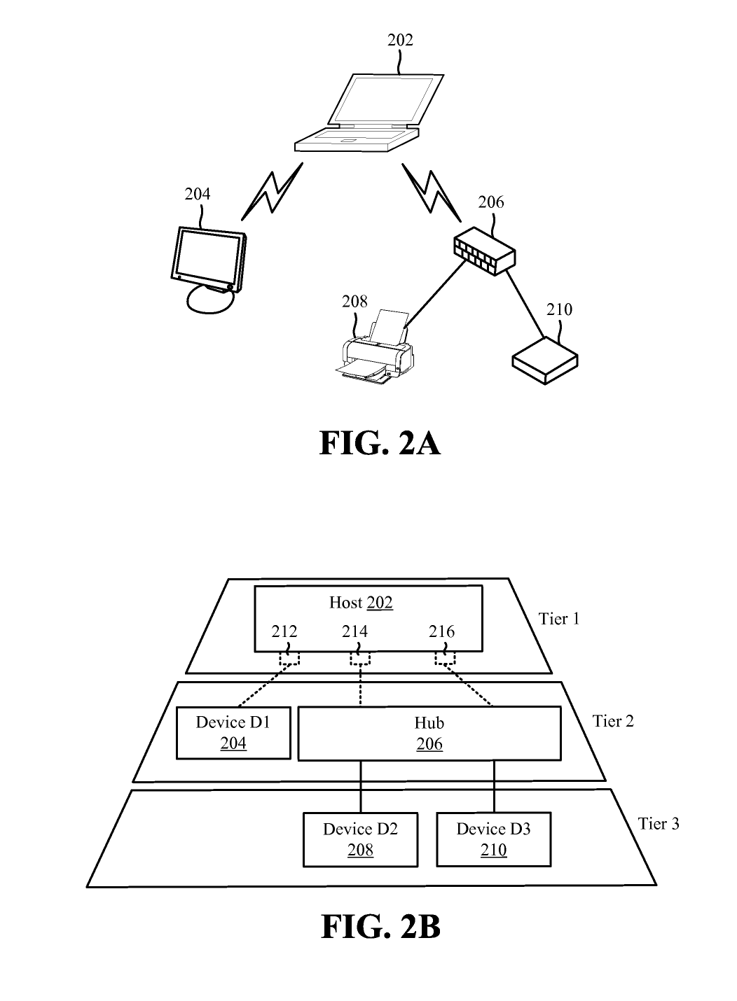

FIGS. 2A-2B are diagrams illustrating an example of a topology of various apparatuses in a communication network. The apparatuses include a host 202 (e.g., a laptop computer), a hub 206 (e.g., a router), and various devices, such as device D1 204 (e.g., a display device), device D2 208 (e.g., a printer device), and device D3 210 (e.g., a storage device). One of ordinary skill in the art will understand that the communication network may include fewer or additional apparatuses relative to the apparatuses illustrated in FIGS. 2A-2B without deviating from the scope of the present disclosure. The communication network may include various tiers, such as Tier 1, Tier 2, and Tier 3, as illustrated in FIG. 2B.

Tier 1 may include the host 202. The host 202 may include a root hub providing various virtual root hub ports 212, 214, 216. The host 202 may communicate wirelessly with one or more devices in Tier 2 via the virtual root hub ports 212, 214, 216. For example, virtual root hub 212 may communicate wirelessly with device D1 204 (e.g., the display device) in Tier 2, and virtual root hubs 214, 216 may communicate wirelessly with the hub 206 (e.g., the router) in Tier 2.

The hub 206 (e.g., the router) may enable communication with downstream devices. For example, the hub 206 (e.g., the router) in Tier 2 may communicate with devices in Tier 3. The hub 206 (e.g., the router) may communicate with the device D2 208 (e.g., the printer device) and the device D3 210 (e.g., the storage device). Some communications received by a device in Tier 3 may originate from a host in Tier 1. For example, the communication received by device D2 208 (e.g., the printer device) may originate from the host 202, and the communication received by device D3 210 (e.g., the storage device) may also originate from the host 202.

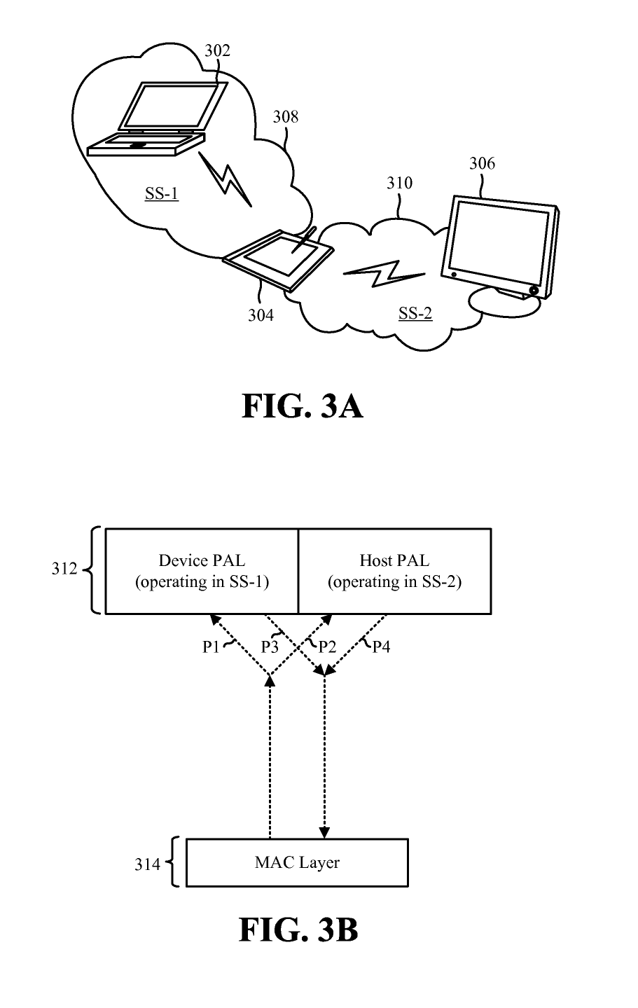

One of ordinary skill in the art will understand that the example illustrated in FIGS. 2A-2B is provided for illustrative purposes and is not intended to limit the scope of the present disclosure. A communication network may have alternative configurations without deviating from the scope of the present disclosure. An example of another communication network within the scope of the present disclosure is provided in FIGS. 3A-3B.

FIGS. 3A-3B are diagrams illustrating another example of a topology of various apparatuses in a communication network. The communication network may include various service sets. For example, the communication network may include a first service set (SS-1) 308 and a second service set (SS-2) 310. Together, the service sets may form a basic service set (BSS). In some configurations, communication in the BSS may be performed in accordance with the protocols of the communication standard sometimes referred to as Institute of Electrical and Electronics Engineers (IEEE) 802.11. One of ordinary skill in the art will understand that communication may, additionally and/or alternatively, be performed in accordance with protocols of other communication standards without deviating from the scope of the present disclosure. Accordingly, any reference herein to IEEE 802.11 is provided for illustrative purposes and shall not be construed as a limitation of the present disclosure.

In some configurations, a single apparatus may perform the operations of a host as well as a device. In FIG. 3A, a non-limiting example of such an apparatus is illustrated as a tablet computer 304. The tablet computer 304 may communicate with the laptop computer 302 in SS-1 308 and may also communicate with the display device 306 in SS-2 310. The tablet computer 304 may operate as a device (e.g., similar to device D1 204, device D2 208, device D3 210) with respect to the laptop computer 302 in SS-1 308. The tablet computer 304 may also operate as a host (e.g., similar to host 202) with respect to the display device 306 in SS-2 310.

More specifically, FIG. 3B illustrates communications between a protocol adaptation layer (PAL) 312 and a MAC layer 314 of the tablet computer 304 illustrated in FIG. 3A. As illustrated in FIG. 3B, the PAL 312 may include a device PAL operating in SS-1 308 as well as a host PAL operating in SS-2 310. A first data packet (P1) may be transmitted from the MAC layer 314 to the device PAL operating in SS-1 308. For example, the laptop computer 302 in SS-1 308 may transmit P1 to the tablet computer 304. A second data packet (P2) may be transmitted from the MAC layer 314 to the host PAL operating in SS-2 310. For example, the display device 306 may transmit P2 to the tablet computer 304. A third data packet (P3) may be transmitted from the device PAL operating in SS-1 308 to the MAC layer 314. For example, the tablet computer 304 may transmit P3 to the laptop computer 302. A fourth data packet (P4) may be transmitted from the host PAL operating in SS-2 310 to the MAC layer 314. For example, the tablet computer 304 may transmit P4 to the display device 306. FIGS. 3A-3B illustrate a non-limiting example of a single apparatus (e.g., tablet computer 304) operating as a device as well as a host. However, such a configuration is provided for illustrative purposes and shall not limit the scope of the present disclosure.

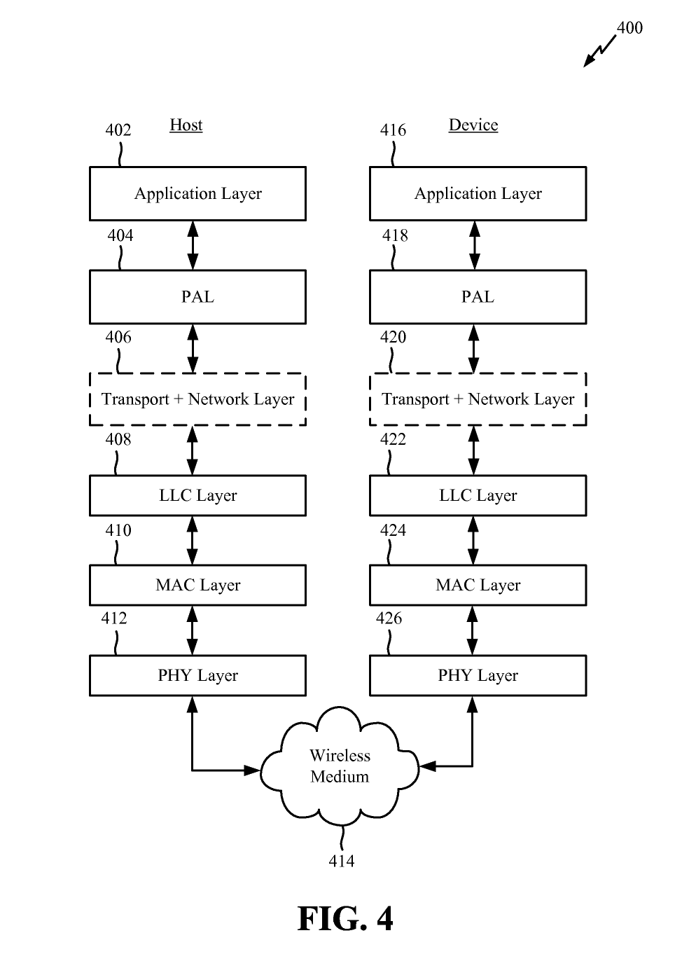

FIG. 4 is a diagram 400 illustrating an example of various protocol layers of a communication system. The protocol layers illustrated in FIG. 4 may be utilized by a host and/or a device, which are described above with reference to FIGS. 2A-2B and FIGS. 3A-3B. However, the various protocol layers illustrated in FIG. 4 shall not be construed as a limitation of the present disclosure. One of ordinary skill in the art will understand that fewer, additional, and/or alternative protocol layers may be implemented without deviating from the scope of the present disclosure. For instance, various protocol layers not illustrated in FIG. 4 may exist between any of the layers illustrated in FIG. 4 without deviating from the scope of the present disclosure. One of ordinary skill in the art will also understand that such protocol layers may be utilized in various configurations, even if not illustrated in FIG. 4, without deviating from the scope of the present disclosure.

In some configurations, data traffic may flow from an upper layer (e.g., application layer 402) to an intermediate layer, such as a PAL 404. An example of a PAL 404 is a media agnostic (MA) universal serial bus (USB) PAL. The MA USB PAL may enable connectivity between a USB host and one or more USB devices, including USB hubs, over wireless mediums, such as IEEE 802.11 and/or Internet protocol (IP) links. The PAL 404 may also perform other functions and/or include other features not described herein without deviating from the scope of the present disclosure. The data traffic may flow from the PAL 404 to another layer, such as the transport and network layer 406.

The transport and network layer 406 may facilitate the flow of the data traffic to one or more devices via IP links. For example, a host and a device may be separated by an IP network. The host and the device may be direct clients of a transmission control protocol (TCP). The data traffic may be packaged into IP datagrams and delivered through TCP connections. However, the transport and network layer 406 may not exist in all configurations of the present disclosure, such as when the data traffic is not being transmitted from the host to the device via IP links. The transport and network layer 406 may also perform other functions and/or include other features not described herein without deviating from the scope of the present disclosure.

The data traffic may flow to a logical link control (LLC) layer 408. The LLC layer 408 may be the upper sublayer of a data link layer. The LLC layer 408 may provide multiplexing mechanisms to enable various network protocols to coexist within a multipoint network and to be transported over the same network medium. The LLC layer 408 may also control data flows as well as provide error management. The LLC layer 408 may also perform other functions and/or include other features not described herein without deviating from the scope of the present disclosure. The LLC layer 408 interface between a network layer (e.g., transport and network layer 406) and a MAC layer (e.g., MAC layer 410).

The data traffic may flow from the LLC layer 408 to the MAC layer 410. The MAC layer 410 may be the lower sublayer of the data link layer. The MAC layer 410 may provide addressing and channel access control mechanisms that enable various terminals or network nodes to communicate within a multiple-access network having a shared medium (e.g., a wireless medium according to IEEE 802.11). The MAC layer 410 may emulate a full-duplex logical communication channel in a multi-point network, and such a channel may provide unicast, multicast, and/or broadcast communication service(s). The MAC layer 410 may also perform other functions and/or include other features not described herein without deviating from the scope of the present disclosure. The MAC layer 410 may interface between a LLC layer (e.g., LLC layer 408) and a network physical (PHY) layer (e.g., PHY layer 412).

The PHY layer 412 may include network hardware transmission technologies. The PHY layer 412 may provide the means for transmitting data traffic. The PHY layer 412 may provide an electrical, mechanical, and/or procedural interface to the transmission medium. The PHY layer 412 may specify various attributes of the data traffic, such as the frequency on which the data traffic is transmitted, the modulating scheme of the data traffic, and other related attributes of the data traffic. The PHY layer 412 may also perform other functions and/or include other features not described herein without deviating from the scope of the present disclosure. The PHY layer 412 may transmit the data traffic to the device via the wireless medium 414. The wireless medium 414 may be in accordance with IEEE 802.11. The wireless medium 414 may also be in accordance with various other technologies. The wireless medium 414 may interface between the PHY layer 412 of the host as well as the PHY layer 426 of the device.

With respect to the device, data traffic may flow from the application layer 416 to the PAL 418. Data traffic may also flow to the transport and network layer 420 and eventually to the LLC layer 422. Data traffic may also flow to the MAC layer 424 and eventually to the PHY layer 426. A description of various features and/or functions of such layers in the device is provided above with reference to the host and, therefore, will not be repeated.

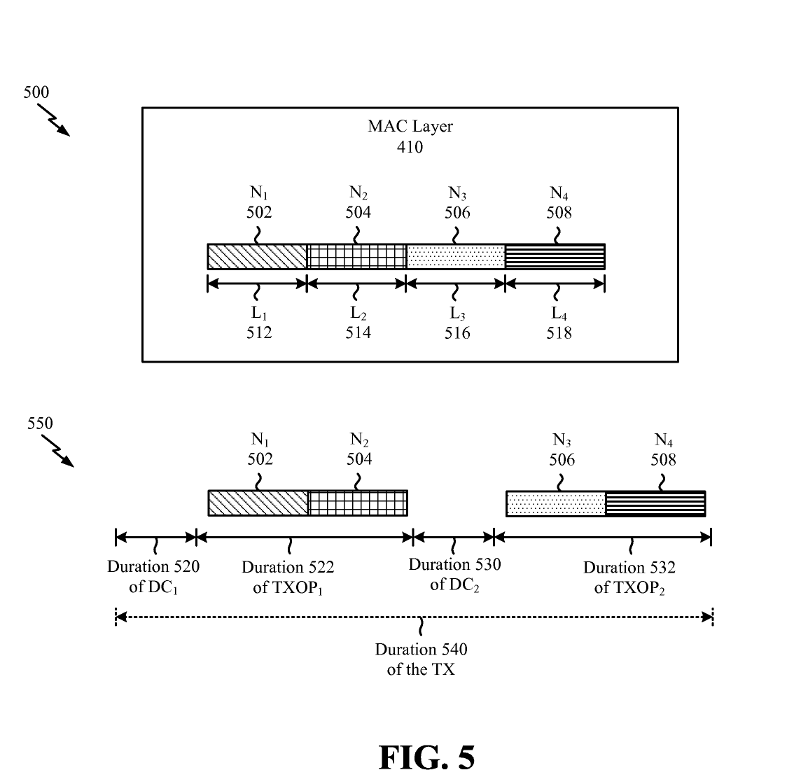

FIG. 5 illustrates an example of communication by a conventional apparatus. More specifically, FIG. 5 illustrates a diagram 500 wherein data is transmitted between the host and the device during various TXOPs. With regard to the host, data is delivered to the MAC layer 410 from a higher layer (e.g., LLC Layer 408, PAL 404, etc.). Such data may include various data frames. For example, the data may include data frames N₁ 502, N₂ 504, N₃ 506, N₄ 508. The data frames N₁ 502, N₂ 504, N₃ 506, N₄ 508 may have respective lengths L₁ 512, L₂ 514, L₃ 516, L₄ 518. The length of each data frame corresponds to its respective data size. The data frame may include various types of data without deviating from the scope of the present disclosure. For example, the data frame may include headers, preambles, and/or payloads. In some configurations, some of the data frames may be a part of an overall data packet. In some configurations, some of the data frames may each be a separate data packet.

Although the example illustrated in FIG. 5 shows four (4) data frames N₁ 502, N₂ 504, N₃ 506, N₄ 508, one of ordinary skill in the art will understand that the data may have any number of data frames without deviating from the scope of the present disclosure. Also, although the example illustrated in FIG. 5 shows that each of the data frames N₁ 502, N₂ 504, N₃ 506, N₄ 508 has approximately the same length L₁ 512, L₂ 514, L₃ 516, L₄ 518, one of ordinary skill in the art will understand that any one or more of the data frames N₁ 502, N₂ 504, N₃ 506, N₄ 508 may have the same or different length relative to another data frame without deviating from the scope of the present disclosure.

The data frame N₁ 502, N₂ 504, N₃ 506, N₄ 508 may be delivered to the MAC layer 410 from an upper layer. Such an upper layer may be any one or more of the layers shown in FIG. 4. As a non-limiting example, the data frames N₁ 502, N₂ 504, N₃ 506, N₄ 508 may be delivered to the MAC layer 410 from the PAL 404. Although various aspects of the present disclosure provided herein may be described with reference to an implementation using the MAC layer 410, one of ordinary skill in the art will understand that such aspects may be implemented using any other layer(s) without deviating from the scope of the present disclosure.

After the data frames N₁ 502, N₂ 504, N₃ 506, N₄ 508 are delivered to the MAC layer 410, the conventional apparatus may determine which of the data frames N₁ 502, N₂ 504, N₃ 506, N₄ 508 can be transmitted in various TXOPs. As described herein, a TXOP may include any one or more aspects of the TXOP described in IEEE 802.11e. Generally, a TXOP is a bounded (e.g., fixed) period of time during which a station transfers data frames. During the TXOP, an apparatus transmits as many data frames as possible, so long as the duration required for such a transmission does not exceed the maximum duration of the TXOP. If the data in the data frames is too large to be transmitted in a single TXOP, then such data is not be transmittable in a single TXOP. That is, an apparatus may determine that an amount of data exceeds a maximum amount of data transmittable in a single TXOP when the amount of data is too large to be transmitted in a single TXOP. Conversely, the apparatus may determine that an amount of data does not exceed an amount of data transmittable in a single TXOP when the amount of data is not too large to be transmitted in a single TXOP. When the data is not transmittable in a single TXOP, the data can be fragmented into smaller portions. Although these smaller portions of data are each transmittable in a separate TXOP, more than one TXOP will be required for the transmission of the totality of the data.

The conventional apparatus may utilize a contention-based system for determining whether to transmit data over a channel. For example, the apparatus may ‘remain quiet’ (e.g., refrain from transmitting) and ‘listen’ (e.g., detect the presence of a signal on the channel) before ‘speaking’ (e.g., transmitting on the channel). The period of time corresponding to ‘remaining quiet’ and ‘listening’ pertains to “Delay Channel access,” which is identified as “DC” in diagram 550 of FIG. 5. In some configurations, the period of time corresponding to ‘remaining quiet’ and ‘listening’ may sometimes be referred to as the medium access delay (e.g., DC₁ and DC₂).

During duration 520 of DC₁, the apparatus may refrain from transmitting and detect the presence of a signal on the channel of interest. The apparatus may determine that a signal exists on that channel when the apparatus detects energy above a certain threshold on that channel. In such instances, the apparatus may determine that the channel is currently unavailable for use. In response, the apparatus may initiate a back-off procedure and, at a later time, initiate another detection of a signal on that channel. If the apparatus does not detect a signal on that channel, the apparatus may proceed with the TXOP (e.g. TXOP₁).

The data frames N₁ 502, N₂ 504, N₃ 506, N₄ 508 may be arranged in various TXOPs. Each TXOP may have a particular duration. For example, TXOP₁ has duration 522, and TXOP₂ has duration 532. Notably, however, the total length of the data frames N₁ 502, N₂ 504, N₃ 506, N₄ 508 exceeds the duration 522 of TXOP₁. Because the total length of the data frames N₁ 502, N₂ 504, N₃ 506, N₄ 508 exceeds the duration 522 of TXOP₁, TXOP₁ cannot accommodate all of the data frames N₁ 502, N₂ 504, N₃ 506, N₄ 508. That is, the amount of data (e.g., the total length of data frames N₁ 502, N₂ 504, N₃ 506, N₄ 508) at the MAC layer 410 exceeds the maximum amount of data transmittable in a single TXOP (e.g., TXOP₁). The maximum amount of data transmittable in a single TXOP may sometimes be referred to as “Pmax.”

Nevertheless, the TXOP may be able to accommodate at least one data frame. For example, as illustrated in FIG. 5, the duration 522 of TXOP₁ can accommodate data frames N₁ 502, N₂ 504. Accordingly, data frames N₁ 502, N₂ 504 are included in TXOP₁. Any data frames that cannot be included in TXOP₁ may be included in a subsequent TXOP. For example, as illustrated in FIG. 5, the data frames N₃ 504, N₄ 508 may be included in TXOP₂.

However, as mentioned above, the conventional apparatus operates according to a contention-based system. Accordingly, the apparatus refrains from transmitting (e.g., ‘waits’) and detects the presence of a signal (e.g., ‘listens’) during duration 530 of DC₂. As such, the apparatus is unable to transmit (e.g., ‘speak’) the remaining data frames N₃ 506, N₄ 508 during duration 530 of DC₂. Because the apparatus is unable to transmit the remaining data frames N₃ 506, N₄ 508 during duration 530 of DC₂, the transmission of the remaining data frames N₃ 506, N₄ 508 is delayed until duration 532 of TXOP₂.

Such a delay (e.g., DC₂) between each period of transmission (e.g., between TXOP₁ and TXOP₂) can have some undesirable effects that adversely impact the user experience. For example, the delay in transmission of the remaining data frames N₃ 506, N₄ 508 may result in queues of data in various layers of the protocol stack (e.g., any of the layers 402, 404, 406, 408, 410, 412 illustrated in FIG. 4) to become longer and possibly congested. As another example, the delay in transmission of the remaining data frames N₃ 506, N₄ 508 may result in latency to be introduced between each period of transmission.

Some types of data are latency-sensitive. In some configurations, data is considered latency-sensitive when a certain amount of delay in transmitting/receiving the data results in a poor user experience. A non-limiting example of latency-sensitive data is isochronous data. Isochronous data may include data that occurs regularly or at equal time intervals. Isochronous transfers may be utilized for transmitting real-time information, such as audio data and video data, and such transmissions may be sent at a constant rate. Isochronous transfers may lack error detection. Isochronous data may be allocated a dedicated portion of an available bandwidth to ensure that the data streams are delivered at a desired rate. Another non-limiting example of latency-sensitive data is interrupt data. Interrupt data may have a limited latency to or from a device, and an interrupt transfer may have a defined polling rate. Interrupt data may include event notifications, characters, and/or coordinates from a pointing device. One of ordinary skill in the art understands that various other types of latency-sensitive data exist and are within the scope of the present disclosure.

The duration 540 of the transmission (TX) for all of the data frames N₁ 502, N₂ 504, N₃ 506, N₄ 508 is illustrated in diagram 550 of FIG. 5. The total duration 540 of the TX includes the duration 520 of DC₁, the duration 522 of TXOP₁, the duration 530 of DC₂, and the duration 532 of TXOP₂.

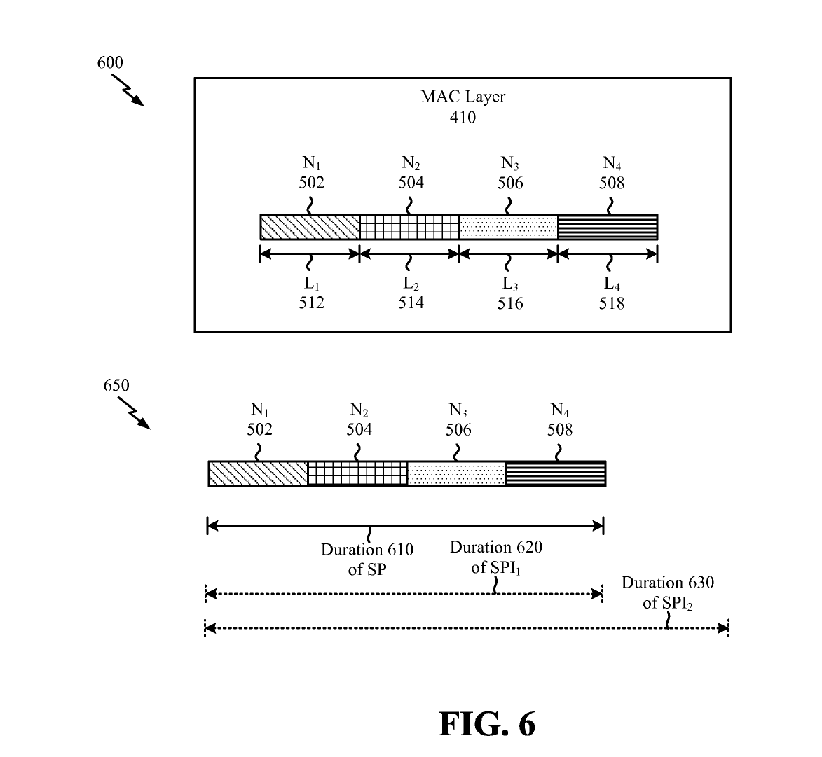

FIG. 6 illustrates an example of communication by an apparatus configured according to various aspects of the present disclosure. More specifically, FIG. 6 illustrates an example of data at the MAC layer being transmitted during a SP. One of ordinary skill in the art will understand that the MAC layer illustrated in FIG. 6 may corresponds to the MAC layer 410 of the host and, alternatively or additionally, to the MAC layer 424 of the device without deviating from the scope of the present disclosure. For the sake of simplicity, but not limitation, such an apparatus (e.g., the host and/or the device) may sometimes be referred to as the ‘apparatus 100.’ However, one of ordinary skill in the art will understand that ‘apparatus 100’ may refer to any or more of the apparatuses described above with reference to any of FIGS. 1, 2A, 2B, 3A and/or 3B. Some aspects illustrated in diagram 600 are described above with reference to FIG. 5 and, therefore, will not be repeated.

Generally, the SP may refer to any period of time that is dedicated by a transmitting apparatus and/or a receiving apparatus for a specific transmission. For instance, a transmitting apparatus and a receiving apparatus can agree upon various parameters (e.g., start and end times of the SP, a duration of the SP, an interval or periodicity of the SP, etc.) associated with the SP. Such parameters may be agreed upon during a handshake procedure that occurs any time prior to the SP. For example, during the handshake procedure, the transmitting apparatus and the receiving apparatus can agree to keep a particular channel available for a transmission of a particular duration. If the transmitting apparatus and the receiving apparatus agree upon such parameters, the transmitting apparatus can expect that particular channel to be available for such a transmission and, accordingly, does not necessarily need to perform the contention-based procedures described above with reference to FIG. 5. In other words, the transmitting apparatus does not necessarily need to ‘listen’ (e.g., detect the presence of another signal on that particular channel) before ‘speaking’ (e.g., transmitting on that particular channel) because the transmitting apparatus and receiving apparatus agreed during the handshake procedure to keep that particular channel available for the duration required for that particular transmission.

Existing communication standards (e.g., IEEE 802.11ad) may describe a static SP and/or a dynamic SP. With regard to IEEE 802.11ad, a personal basic service set (PBSS) control point (PCP) may poll a directional multi-gig (DMG) station (STA) at the beginning of each beacon interval (BI). The DMG STA may respond with a service period request (SPR). Subsequently, the PCP may respond with a grant, which is applicable to the BI under consideration. However, such communication standards do not describe the specific parameters to which the apparatuses should be set in order to reduce the limitations described above with reference to the conventional apparatus (e.g., the limitations associated with congested queues and/or transmission latency).

According to various aspects of the present disclosure, the apparatus 100 may set a duration 610 of the SP. Information pertaining to the amount and/or size of data at a higher layer (e.g., PAL 404) may be provided to a lower layer (e.g., MAC layer 410) via a new primitive (e.g., a parameter called “wBytesPerInterval”). The duration of the SP may be set according to the duration required for transmitting that data. For example, the duration of the SP may be set such that the duration of the SP is greater than or equal to the duration required for transmitting that data. Diagram 650 illustrates an example of such a setting. For example, the duration 610 of the SP is set such that the duration 610 of the SP equals the duration required for transmitting all of the data frames N₁ 502, N₂ 504, N₃ 506, N₄ 508. That is, the duration 610 of the SP is equal to the sum of the duration required for transmitting N₁ 502 (e.g., L₁ 512), the duration required for transmitting N₂ 504 (e.g., L₂ 514), the duration required for transmitting N₃ 506 (e.g., L₃ 516), and the duration required for transmitting N₄ 508 (e.g., L₄ 518). Although the example illustrated in FIG. 5 shows that the duration 610 of the SP is equal to the duration required for transmitting all of the data frames N₁ 502, N₂ 504, N₃ 506, N₄ 508, one of ordinary skill in the art will understand that the duration 610 of the SP may also be greater than the duration required for transmitting all of the data frames N₁ 502, N₂ 504, N₃ 506, N₄ 508 without deviating from the scope of the present disclosure. Various aspects of the present disclosure may also be described by following mathematical expression: SP≧n*l, wherein SP represents the duration of the SP, n represents the number of data frames (e.g., data frames N₁ 502, N₂ 504, N₃ 506, N₄ 508), and l represents the average length (e.g., duration) of such data frames.

According to various aspects of the present disclosure, the apparatus 100 may set a duration of an SPI to be greater than or equal to the duration 610 of the SP and less than or equal to a duration for transmitting the data without using the SP. That is, the apparatus 100 may set the duration of the SPI to be greater than or equal to the duration 610 of the SP and less than or equal to the duration for transmitting the data using two (or more) TXOPs. Generally, the SPI refers to a periodicity or interval of repetition of the SP. The SP occurs during a portion of the SPI. That is, each SPI may include at least one SP. After one SPI ends, another SPI may begin. Diagram 650 illustrates two non-limiting examples pertaining to the SPI. As a first example, the apparatus 100 may set a duration 620 of SPI₁ to be equal to the duration 610 of the SP. That is, the duration 620 of SPI₁ is equal to the duration required for transmitting all of the data frames N₁ 502, N₂ 504, N₃ 506, N₄ 508. As a second example, the apparatus 100 may set a duration 630 of SPI₂ to be greater than the duration 610 of the SP. That is, the duration 630 of SPI₂ is greater than the duration required for transmitting all of the data frames N₁ 502, N₂ 504, N₃ 506, N₄ 508. Nevertheless, in both of these examples, the durations 620, 630 of these SPIs (e.g., SPI₁, SPI₂) is less than or equal to the duration 540 (see FIG. 5) for transmitting the data without using the SP (e.g., using two or more TXOPs). That is, the durations 620, 630 of these SPIs (e.g., SPI₁, SPI₂) is less than or equal to the sum of the duration 520 of DC₁, the duration 522 of TXOP₁, the duration 530 of DC₂, and the duration 532 of TXOP₂ (see FIG. 5).

Various aspects of the present disclosure may be described by the following mathematical expression: SP≦SPI≦DurationTX, wherein SP represents the duration of the SP, SPI represents the duration of the SPI, and DurationTX represents the duration for the transmission without using the SP (e.g., the duration for the transmission using two or more TXOPs). In some configurations, DurationTX may be determined using the following mathematical expression: DurationTX=(n*l)/R+m*DC, wherein n represents the number of frames (e.g., data frames N₁ 502, N₂ 504, N₃ 506, N₄ 508), l represents the average length (e.g., duration) of such data frames, R represents a PHY data rate, m represents the number of TXOPs (e.g., diagram 550 illustrates two TXOPs−TXOP₁ and TXOP₂—thus, m=2), and DC represents the average duration of the medium access delay (e.g., the average of duration 520 of DC₁ and duration 530 of DC₂). In some configurations, m may be determined using the following mathematical expression: m=(n*l)/Pmax, wherein Pmax represents the maximum amount of data transmittable in a single TXOP.

In some configurations, the duration of the SP and/or the duration of the SPI are set based on an indicator. A non-limiting example of such an indicator is a flag. Another non-limiting example of such an indicator is one or more bit values included in a header, a subheader, or a payload of the data frames (e.g., the data frames N₁ 502, N₂ 504, N₃ 506, N₄ 508) described in greater detail herein. One of ordinary skill will understand that such an indicator may be in various forms and have various characteristics without deviating from the scope of the present disclosure.

The indicator (e.g., flag) may indicate a latency requirement of the data. Some data (e.g., audio data) may be more latency-sensitive relative to other data (e.g., non-audio data). The indicator (e.g., flag) may be used to set the duration of the SP and/or the duration of the SPI such that the latency requirements of the data are satisfied. In some circumstances, the data frames N₁ 502, N₂ 504, N₃ 506, N₄ 508 may have relatively high latency-sensitivity. Because the data frames N₁ 502, N₂ 504, N₃ 506, N₄ 508 have relatively high latency-sensitivity, the duration of the SPI may be set such to the duration 620 of SPI₁. Such a setting minimizes the medium access delay (e.g., DC₁, DC₂), thereby increasing the likelihood that the data frames N₁ 502, N₂ 504, N₃ 506, N₄ 508 will be transferred in a manner that satisfies the latency requirements of that particular data. In some other circumstances, the data frames N₁ 502, N₂ 504, N₃ 506, N₄ 508 may have relatively low latency-sensitivity. Because the data frames N₁ 502, N₂ 504, N₃ 506, N₄ 508 have relatively low latency-sensitivity, the duration of the SPI may be set such to the duration 630 of SPI₂. Although such a setting does not necessarily ensure the lowest possible medium access delay (e.g., DC₁, DC₂), the data frames N₁ 502, N₂ 504, N₃ 506, N₄ 508 will nonetheless be transferred in a manner that satisfies the latency requirements of that particular data.

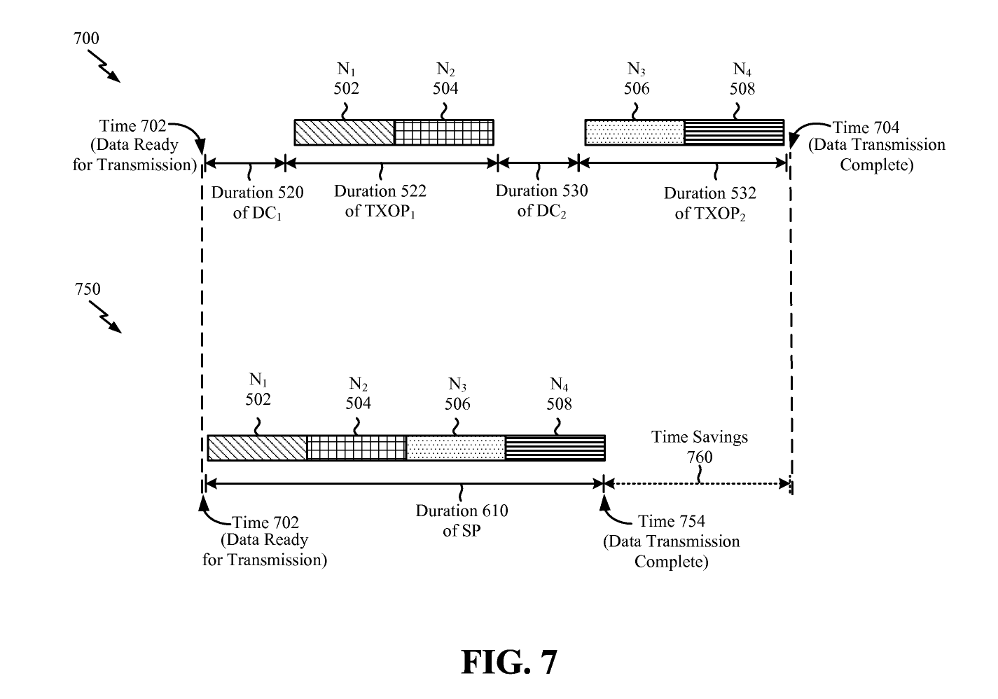

FIG. 7 illustrates a comparison between communication by the conventional apparatus and communication by the apparatus configured according to various aspects of the present disclosure. Diagram 700 illustrates an example of data transmission according to various aspects of the conventional apparatus. (Diagram 700 illustrates various aspects illustrated in diagram 550 of FIG. 5.) Diagram 750 illustrates an example of data transmission according to various aspects of the apparatus 100. (Diagram 700 illustrates various aspects illustrated in diagram 650 of FIG. 6.) A comparison between diagram 700 and diagram 750 reveals various benefits of the apparatus 100 relative to the conventional apparatus.

At time 702, the data is ready for transmission. With regard to the conventional apparatus, as illustrated in diagram 700, the data cannot be transmitted immediately at time 702. For example, the duration 520 of DC₁ elapses before the data is transmitted during TXOP₁. The data (e.g., data frames N₁ 502, N₂ 504) are transmitted during duration 522 of TXOP₁. Some of the data frames (e.g., data frames N₃ 506, N₄ 508) are transmitted during the duration 532 of TXOP₂, which begins after the duration 530 of DC₂. For the conventional apparatus, data transmission is not complete until time 704.

In comparison, with regard to the apparatus 100, as illustrated in diagram 750, the data may be transmitted immediately (or approximately) at time 702. At time 702, the data is ready for transmission. Notably, the conventional apparatus does not include such aspects of the apparatus 100. Furthermore, the apparatus 100 transmits all of the data frames N₁ 502, N₂ 504, N₃ 506, N₄ 508 in a single SP (e.g., during duration 610 of the SP). Because all of the data frames N₁ 502, N₂ 504, N₃ 506, N₄ 508 are transmitted in a single SP, the apparatus 100 does not suffer from latency that is added during the medium access delays, such as those of DC₁ and DC₂ of the conventional apparatus (see diagram 700). In other words, in some configurations, the duration of the SP and/or the duration of the SPI are set such that the medium access delay (e.g., DC₁ and DC₂) is minimized (e.g., less than the medium access delay for transmitting the data using two or more TXOPs).

As illustrated in diagram 750, the apparatus 100 completes transmission of all of the data frames N₁ 502, N₂ 504, N₃ 506, N₄ 508 at time 754. Notably, time 754 is earlier than time 704, which is the time at which the conventional apparatus completes data transmission. Accordingly, a benefit of the apparatus 100 is time savings 760. The time savings 760 may refer to the difference between the time (e.g., time 704) at which the conventional apparatus completes data transmission and the time (e.g., time 754) at which the apparatus 100 completes data transmission. In some configurations, a total for the time savings 760 may be determined using the following mathematical expression: Total Time Savings=m*DC.

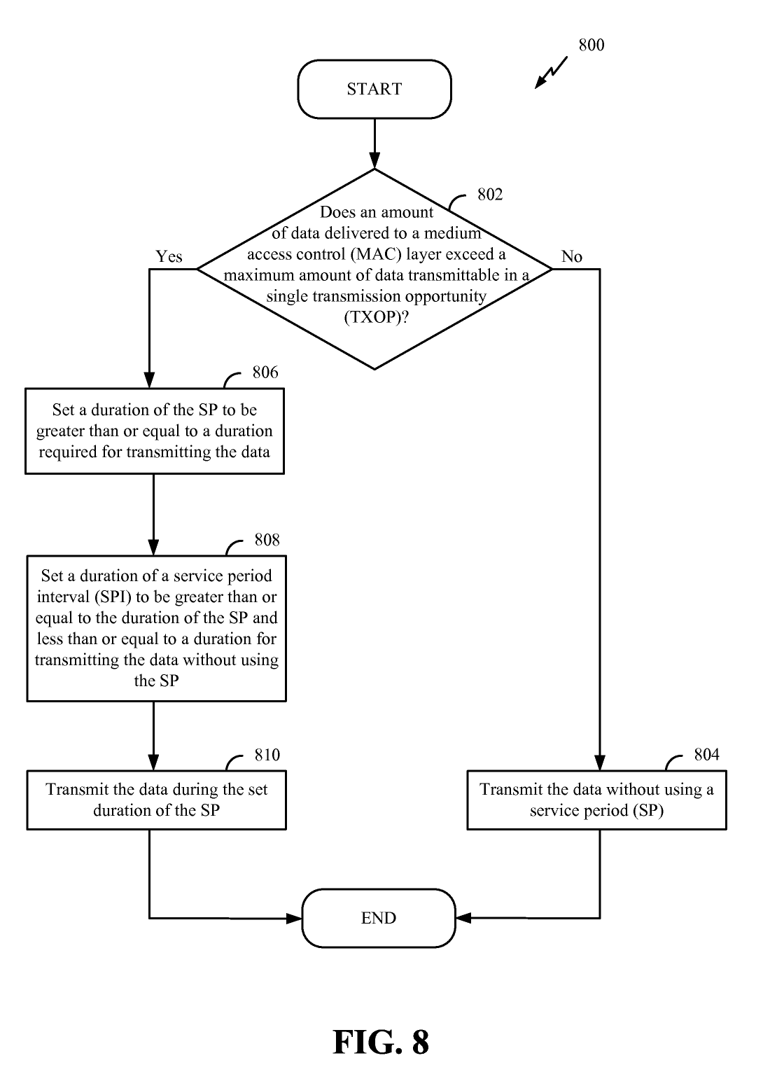

FIG. 8 is a diagram 800 illustrating various methods and/or processes performed by the apparatus configured according to various aspects of the present disclosure. Such methods and/or processes may be performed by the apparatus 100. At block 802, the apparatus 100 may determine whether an amount of data at the MAC layer 410 exceeds a maximum amount of data transmittable in a single TXOP. For example, referring to FIG. 5, the apparatus 100 may determine whether the sum of the lengths L₁ 512, L₂ 514, L₃ 516, L₄ 518 of the data frames N₁ 502, N₂ 504, N₃ 506, N₄ 508 exceeds the duration 522 of TXOP₁. If the sum of the lengths L₁ 512, L₂ 514, L₃ 516, L₄ 518 of the data frames N₁ 502, N₂ 504, N₃ 506, N₄ 508 exceeds the duration 522 of TXOP₁, the amount of data at the MAC layer 410 exceeds the maximum amount of data transmittable in a single TXOP. However, if the sum of the lengths L₁ 512, L₂ 514, L₃ 516, L₄ 518 of the data frames N₁ 502, N₂ 504, N₃ 506, N₄ 508 does not exceed the duration 522 of TXOP₁, the amount of data at the MAC layer 410 does not exceed the maximum amount of data transmittable in a single TXOP.

On the one hand, if the amount of data at the MAC layer 410 does not exceed the maximum amount of data transmittable in the single TXOP, at block 802, the apparatus 100 may transmit the data without using a SP. Instead of using the SP for the transmission, the apparatus 100 may utilize a TXOP for the transmission. For example, referring to FIG. 5, if the sum of the lengths L₁ 512, L₂ 514, L₃ 516, L₄ 518 of the data frames N₁ 502, N₂ 504, N₃ 506, N₄ 508 does not exceed the duration 522 of TXOP₁, the apparatus 100 may transmit the data frames N₁ 502, N₂ 504, N₃ 506, N₄ 508 during the duration 522 of TXOP₁.

On the other hand, if the amount of data at the MAC layer 410 exceeds the maximum amount of data transmittable in the single TXOP, at block 804, the apparatus 100 may set a duration of the SP to be greater than or equal to a duration required for transmitting the data. For example, referring to FIG. 6, the apparatus 100 may set the duration of the SP to the duration 610. In this example, the duration 610 of the SP equals the duration required for transmitting all of the data frames N₁ 502, N₂ 504, N₃ 506, N₄ 508. That is, the duration 610 of the SP is equal to the sum of the duration required for transmitting N₁ 502 (e.g., L₁ 512), the duration required for transmitting N₂ 504 (e.g., L₂ 514), the duration required for transmitting N₃ 506 (e.g., L₃ 516), and the duration required for transmitting N₄ 508 (e.g., L₄ 518). Subsequently, also at block 804, the apparatus 100 may transmit the data during the set duration (e.g., duration 610) of the SP.

At block 808, the apparatus 100 may set a duration of the SPI to be greater than or equal to the duration of the SP and less than or equal to a duration for transmitting the data without using the SP (e.g., using two or more TXOPs). For example, referring to FIG. 6, the apparatus 100 may set a duration 620 of SPI₁ to be equal to the duration 610 of the SP. That is, the duration 620 of SPI₁ is equal to the duration required for transmitting all of the data frames N₁ 502, N₂ 504, N₃ 506, N₄ 508. Nevertheless, the duration 620 of SPI₁ is less than or equal to the duration 540 (see FIG. 5) for transmitting the data without using the SP (e.g., using two or more TXOPs). That is, the duration 620 of the SPI₁ is less than or equal to the sum of the duration 520 of DC₁, the duration 522 of TXOP₁, the duration 530 of DC₂, and the duration 532 of TXOP₂.

At block 810, the apparatus may transmit the data during the set duration of the SP. For example, referring to FIG. 6, the apparatus 100 may transmit the data frames N₁ 502, N₂ 504, N₃ 506, N₄ 508 during the duration 610 of the SP. Various other methods and/or processes may follow block 810, even though not illustrated in FIG. 8.

The methods and/or processes described with reference to FIG. 8 are provided for illustrative purposes and are not intended to limit the scope of the present disclosure. The methods and/or processes described with reference to FIG. 8 may be performed in sequences different from those illustrated therein without deviating from the scope of the present disclosure. Additionally, some or all of the methods and/or processes described with reference to FIG. 8 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method of wireless communication by an apparatus, the method comprising:
determining whether an amount of data at a medium access control (MAC) layer at the apparatus exceeds a maximum amount of data transmittable in a single transmission opportunity (TXOP); and
if the amount of data at the MAC layer exceeds the maximum amount of data transmittable in the single TXOP, setting a duration of a service period (SP) for transmission of the data to be greater than or equal to a duration required for transmitting the data, and transmitting the data during the set duration of the SP.

2. The method of claim 1, further comprising:
setting a duration of a service period interval (SPI) to be greater than or equal to the duration of the SP and less than or equal to a duration for transmitting the data using two or more TXOPs, wherein the SPI corresponds to a periodicity of the SP.

3. The method of claim 2, wherein the duration of the SP and the duration of the SPI are set such that a medium access delay for transmitting the data is less than a medium access delay for transmitting the data using two or more TXOPs.

4. The method of claim 2, wherein the duration of the SP and the duration of the SPI are set based on an indicator indicating a latency requirement of the data.

5. The method of claim 1, wherein the data comprises latency-sensitive data.

6. The method of claim 5, wherein the latency-sensitive data comprises at least one of isochronous data or interrupt data.

7. The method of claim 1, further comprising:
if the amount of data at the MAC layer does not exceed the maximum amount of data transmittable in the single TXOP, transmitting the data using the single TXOP.

8. An apparatus for wireless communication, the apparatus comprising:
a memory;
a transceiver; and
at least one processor communicatively coupled to the memory and the transceiver, wherein the at least one processor is configured to:
determine whether an amount of data at a medium access control (MAC) layer at the apparatus exceeds a maximum amount of data transmittable in a single transmission opportunity (TXOP); and
if the amount of data at the MAC layer exceeds the maximum amount of data transmittable in the single TXOP, set a duration of a service period (SP) for transmission of the data to be greater than or equal to a duration required for transmitting the data, and utilize the transceiver to transmit the data during the set duration of the SP.

9. The apparatus of claim 8, wherein the at least one processor is further configured to:
set a duration of a service period interval (SPI) to be greater than or equal to the duration of the SP and less than or equal to a duration for transmitting the data using two or more TXOPs, wherein the SPI corresponds to a periodicity of the SP.

10. The apparatus of claim 9, wherein the duration of the SP and the duration of the SPI are set such that a medium access delay for transmitting the data is less than a medium access delay for transmitting the data using two or more TXOPs.

11. The apparatus of claim 9, wherein the duration of the SP and the duration of the SPI are set based on an indicator indicating a latency requirement of the data.

12. The apparatus of claim 8, wherein the data comprises latency-sensitive data.

13. The apparatus of claim 12, wherein the latency-sensitive data comprises at least one of isochronous data or interrupt data.

14. The apparatus of claim 8, wherein the at least one processor is further configured to:
if the amount of data at the MAC layer does not exceed the maximum amount of data transmittable in the single TXOP, utilize the transceiver to transmit the data using the single TXOP.

15. A computer-readable medium comprising computer-executable code configured for:
determining whether an amount of data at a medium access control (MAC) layer at an apparatus exceeds a maximum amount of data transmittable in a single transmission opportunity (TXOP); and
if the amount of data at the MAC layer exceeds the maximum amount of data transmittable in the single TXOP, setting a duration of a service period (SP) for transmission of the data to be greater than or equal to a duration required for transmitting the data, and transmitting the data during the set duration of the SP.

16. The computer-readable medium of claim 15, wherein the computer-executable code is further configured for:
setting a duration of a service period interval (SPI) to be greater than or equal to the duration of the SP and less than or equal to a duration for transmitting the data using two or more TXOPs, wherein the SPI corresponds to a periodicity of the SP.

17. The computer-readable medium of claim 16, wherein the duration of the SP and the duration of the SPI are set such that a medium access delay for transmitting the data is less than a medium access delay for transmitting the data using two or more TXOPs.

18. The computer-readable medium of claim 16, wherein the duration of the SP and the duration of the SPI are set based on an indicator indicating a latency requirement of the data.

19. The computer-readable medium of claim 15, wherein the data comprises latency-sensitive data.

20. The computer-readable medium of claim 19, wherein the latency-sensitive data comprises at least one of isochronous data or interrupt data.

21. The computer-readable medium of claim 15, wherein the computer-executable code is further configured for:
if the amount of data at the MAC layer does not exceed the maximum amount of data transmittable in the single TXOP, transmitting the data using the single TXOP.

22. The computer-readable medium of claim 16, wherein:
the duration of the SP and the duration of the SPI are set such that a medium access delay for transmitting the data is less than a medium access delay for transmitting the data using two or more TXOPs; and
the data comprises latency-sensitive data comprising at least one of isochronous data or interrupt data.

23. An apparatus for wireless communication, the apparatus comprising:
means for determining whether an amount of data at a medium access control (MAC) layer at the apparatus exceeds a maximum amount of data transmittable in a single transmission opportunity (TXOP); and
means for setting a duration of a service period (SP) for transmission of the data to be greater than or equal to a duration required for transmitting the data and transmitting the data during the set duration of the SP, if the amount of data at the MAC layer exceeds the maximum amount of data transmittable in the single TXOP.

24. The apparatus of claim 23, further comprising:
means for setting a duration of a service period interval (SPI) to be greater than or equal to the duration of the SP and less than or equal to a duration for transmitting the data using two or more TXOPs, wherein the SPI corresponds to a periodicity of the SP.

25. The apparatus of claim 24, wherein the duration of the SP and the duration of the SPI are set such that a medium access delay for transmitting the data is less than a medium access delay for transmitting the data using two or more TXOPs.

26. The apparatus of claim 24, wherein the duration of the SP and the duration of the SPI are set based on an indicator indicating a latency requirement of the data.

27. The apparatus of claim 23, wherein the data comprises latency-sensitive data.

28. The apparatus of claim 27, wherein the latency-sensitive data comprises at least one of isochronous data or interrupt data.

29. The apparatus of claim 23, further comprising:
means for transmitting the data using the single TXOP, if the amount of data at the MAC layer does not exceed the maximum amount of data transmittable in the single TXOP.

30. The apparatus of claim 24, wherein:
the duration of the SP and the duration of the SPI are set such that a medium access delay for transmitting the data is less than a medium access delay for transmitting the data using two or more TXOPs; and
the data comprises latency-sensitive data comprising at least one of isochronous data or interrupt data.
